(19) United States
(12) Patent Application Publication
(10) Pub. No.: US 2008/0021786 A1
(43) Pub. Date: Jan. 24, 2008

(54) System and method for electronic delivery of media

(75) Inventors: Are Stenberg, Oslo (NO); Nikolai Petchenikov, Sofia (BG); Stephen J. Sogin, Occidental, CA (US); William Robert Law, San Francisco, CA (US); Jonathan Sharif Marx Stark, Santa Ana, CA (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Primiro LLC, San Jose, CA (US)

(21) Appl. No.: 11/904,382

(22) Filed: Sep. 27, 2007

Related U.S. Application Data
(63) Continuation-in-part of application No. 11/639,670, filed on Dec. 15, 2006.
(60) Provisional application No. 60/751,722, filed on Dec. 19, 2005.

(51) Int. Cl. G06Q 30/00

(52) U.S. Cl. 705/14

(57) ABSTRACT

The present disclosure provides for a system for electronic distribution of media. The system includes media which has instructions having contact information, a unique code identifying the media and an advertisement associated therewith. The system also includes a computing device configured to transmit an electronic message based on the contact information requesting electronic content corresponding to the media, the electronic message including the unique code. The system further includes a server configured to store the electronic content and to catalogue the electronic content by the unique code. The server is further configured to determine effectiveness of the advertisement based on number of electronic messages requesting electronic content corresponding to the media.

### CROSS REFERENCE TO RELATED APPLICATION

The present application is a continuation-in-part of U.S. application Ser. No. 11/639,670 filed on Dec. 15, 2006 which claims the benefit of and priority to U.S. Provisional Application Ser. No. 60/751,722 filed on Dec. 19, 2005, the entire disclosure of all of which is incorporated by reference herein.

### BACKGROUND

1. Field

The present disclosure relates generally to data processing and network systems, and more particularly, to a method and system for providing a user with individual electronic content corresponding to specific media. The present disclosure also relates to a system and method for assessing effectiveness of media advertisement.

2. Description of the Related Art

Presently, media access is restricted to its source. Print media (e.g., newspapers, magazines, etc.) typically require people to have a hardcopy thereof. Although electronic media is more accessible and easier to distribute, it may only be accessed by connecting to the source (e.g., network server). Typical media distribution methods do not allow users to permanently save a copy of the content for later use. Therefore, many users are unable to keep a permanent copy of media content, which may be stored and shared with other users.

The current solutions to store and share content from printed media have several weaknesses. Users must store and organize content in paper format, something that requires space and makes the retrieval and sharing of the content cumbersome. Many users are in a situation where they cannot keep the magazine/newspaper or tear out the relevant pages for their own use. Magazines often have an average of five to seven readers per copy, and thus, not all of the readers can keep the same magazine or the individual pages thereof.

Regarding electronic media, users can not conveniently obtain an electronic copy of the content. If they have to go on-line to download content or they have to manually scan a printed version of the content, they need to invest significant time and effort. Users can not request, store, organize or share the content instantly as they read the content—they have to wait until they are close to a PC, a copy machine or a scanner. Many users lack the desire to spend the required time to do this, or they might simply forget to do so.

In order to retain a copy of particular content in a magazine or a newspaper (e.g., a specific article or advertisement) the user must photocopy or scan the content, which requires access to special equipment, or physically remove the relevant pages. Sharing multiple copies of print media poses problems in that the person who wishes to share the content must either purchase multiple copies of the content or be in proximity to a copying device. This becomes a particularly difficult issue if the print content in question is, by the nature of its size, location, or circumstance of the person wishing to obtain copies, not able to be reproduced.

Saving digital content electronically is complicated for many reasons. First, saving certain types of electronic content, such as web pages, can result in loss of formatting and lack of readability. Second, certain types of electronic devices (e.g., mobile phones) lack the capacity to perform such tasks due to hardware limitations (e.g., relatively small storage capacity).

Another issue with print media is that one must scan the content to find the article, advertisement, or a specific passage of interest. Content readers must know exactly which periodical, which issue, and in which article the specific content is printed. Performing this search manually is difficult and time-consuming.

A further problem with printed media relates to assessment of effectiveness of advertisement printed therein. Conventional advertising rates are determined based on the number of subscribers, since subscriber information is the only available source of data related to readership. However, subscribers represent only a fraction of the actual readership of the magazines, which prevents an accurate assessment of actual readership and advertisement exposure.

Therefore, there is a need for a system and method for providing publishers and/or advertisers with more detailed readership information relating to effectiveness of printed advertising.

### SUMMARY

A system and method according to the present disclosure provide a solution that enables users to easily request and obtain electronic content relating to media. Each piece of content is associated with an advertisement and includes a unique code that the user can send via a Short Message Service (“SMS”) via a mobile phone in order to request the electronic content. The request is forwarded to a server that receives this SMS, and sends the content in electronic format (e.g., a PDF format, rich-text format, audio, video, or other multi-media format, etc.) to both the user's e-mail address and to a personalized online content library. In the same manner, the user can send the media-based content directly to another recipient by adding that recipient's e-mail address or mobile phone number in the SMS. The server tabulates the total number of requests for a particular piece of content (e.g., article, media) and determines effectiveness of the advertisement associated therewith based on the number of requests. In addition, the server collects the email address and mobile number of the people who confirm their request for the content in question. Finally, the electronic versions of the print content may include links to e-commerce engines allowing the user to purchase additional content and/or products.

According to one aspect of the present disclosure, a system for electronic distribution of media is disclosed. The system includes media which has instructions having contact information, a unique code identifying the media and an advertisement associated therewith. The system also includes a computing device configured to transmit an electronic message based on the contact information requesting electronic content corresponding to the media, the electronic message including the unique code. The system further includes a server configured to store the electronic content and to catalogue the electronic content by the unique code. The server is further configured to determine effectiveness of the advertisement based on number of electronic messages requesting electronic content corresponding to the media.

A method for electronic distribution of media is also contemplated by the present disclosure. The method includes the steps of providing media including instructions having contact information, a unique code identifying the media and an advertisement associated therewith and cataloguing electronic content corresponding to the media to assign the unique code thereto. The method also includes the steps of transmitting an electronic message based on the contact information, the electronic message including the unique code and determining effectiveness of the advertisement based on the number of electronic messages requesting electronic content corresponding to the media.

According to another aspect of the present disclosure, a system for electronic distribution of media is provided. The system includes media which has instructions having contact information, a unique code identifying the media, and an advertisement associated therewith. The system also includes a computing device configured to transmit an electronic message based on the contact information, requesting electronic content corresponding to the media, the electronic message including the unique code. The system further includes a server configured to store the electronic content and to catalogue the electronic content according to the unique code. The server is further configured to record information relating to electronic messages requesting electronic content corresponding to the media and to determine effectiveness of the at least one advertisement based on a ratio between number of electronic messages requesting electronic content corresponding to the media and number of media in circulation.

According to a further aspect of the present disclosure, a system for electronic distribution of media is provided. The system includes a computing device having an image-capturing module configured to capture an image of at least a portion of a media. The computing device is configured to transmit an electronic message including the image. The electronic message requests electronic content corresponding to the media. The system also includes one or more servers configured to store the electronic content and to catalogue the electronic content. The server is further configured to analyze the image to identify the media and to generate an individualized online library, and thereafter deliver the electronic content to at least one of the computing device, an e-mail box and the online library.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a system for electronic delivery of media according to the present disclosure;

FIG. 2 is a flow diagram showing a method for electronic delivery of media according to the present disclosure;

FIG. 3 is a schematic diagram of a system for determining effectiveness of printed media advertising according to the present disclosure; and

FIG. 4 is a flow diagram showing a method for determining effectiveness of printed media advertising according to the present disclosure.

### DETAILED DESCRIPTION

Particular embodiments of the present disclosure will be described hereinbelow with reference to the accompanying drawings. In the following description, well-known functions or constructions are not described in detail to avoid obscuring the present disclosure in unnecessary detail.

It is to be understood that the present disclosure may be implemented in various forms of hardware, software, firmware, networks, special purpose processors, or a combination thereof. In one embodiment, the present disclosure may be implemented in software as an application program tangibly embodied on a program storage device. The application program may be uploaded to, and executed by, a computer system comprising any suitable architecture such as a personal computer, a workstation or server. In embodiments, the system is implemented on a computer platform having hardware such as one or more central processing units (CPU) (e.g., processor), a random access memory (RAM), a read only memory (ROM) and input/output (I/O) interface(s) such as a keyboard, cursor control device (e.g., a mouse or joystick) and display device.

A system bus couples the various components and may be any of several types of bus structures including a memory bus or memory controller, a peripheral bus, and a local bus using any of a variety of bus architectures. The computer platform also includes an operating system and micro instruction code, which may be stored in a data storage device. The various processes and functions described herein may either be part of the micro instruction code or part of the application program (or a combination thereof) which is executed via the operating system. In addition, various other peripheral devices such as, for example, additional storage devices or a printer may be connected to the computer platform by various interfaces and bus structures, such as a parallel port, serial port or universal serial bus (USB).

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

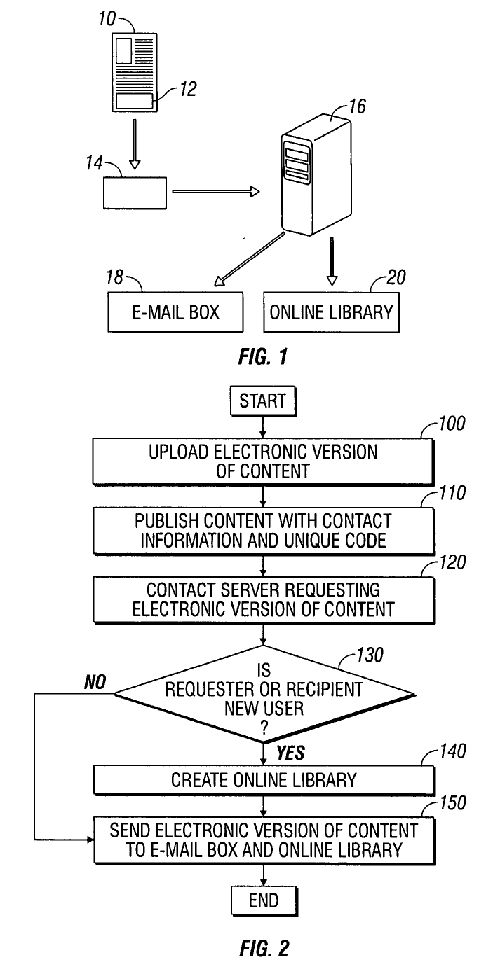

FIG. 1 shows a system according to the present disclosure which allows users to request and receive media electronically. Providers (e.g., publishers) distribute media 10, such as printed articles (e.g., magazines, newspapers, brochures, etc.), billboards and/or electronic media (e.g., websites). The media 10 includes instructions 12 which provide guidance to users on how to obtain electronic content relating to the media 10. The electronic content may include, but is not limited to, an electronic document version of the media 10 (e.g., PDF, rich-text, HTML, ASCII text, etc.), on-demand rich media presentations (e.g., webcasts, podcasts, streaming audio and/or video, etc.), as well as supplemental electronic content, such as advertisements, additional product information, and/or coupons in response to user requests. In addition, the media 10 may be a product label (e.g., wine label) attached to merchandise (e.g., wine bottle) and the electronic content may be additional product information about the specific product (e.g., region, grapes, and other viticulture information).

In particular, the instructions 12 include contact information for the entity responsible for electronically distributing the media 10 and a unique code associated with and identifying the media 10. The contact information may be a phone number, an e-mail address, SMS number, etc. In addition, first-time users of the service are instructed to provide an e-mail address for an e-mail box 18 or an e-mail address for another recipient. As described in more detail below, electronic content as well as additional instructions for accessing an individualized online library 20 are delivered to the e-mail box 18.

Users desiring electronic content relating to the media 10 send an electronic message (e.g., SMS, e-mail, etc.) to the specified contact information with the unique code referencing the media 10 in order to request the electronic content. This is accomplished using a computing device 14 suited to transmit electronic messages (e.g., cellular phone, PDA, personal computer, media player, etc.). First-time users of the service specify their e-mail address in the SMS message together with the code referencing media 10. The computing device 14 is configured to access the e-mail box 18 to retrieve e-messages as well as to perform a variety of other tasks, e.g., web-browsing for accessing the online library 20.

The request is sent to a server 16 which processes the request by retrieving the article and forwarding the article to the user. The request may be sent over a wide variety of networks, such as a local area network (LAN), wide area network (WAN), the Internet, cellular, WiFi, wireless broadband, and/or any known network that couples a plurality of computing devices to enable various modes of communication via network messages. Those skilled in the art will appreciate that a plurality of servers may be utilized in such a configuration.

The server 16 includes a plurality of electronic content (e.g., electronic versions of the media 10, coupons, advertisements, etc.) which are uploaded by providers. The server 16 catalogues the electronic content by assigning a unique code to each file thereby cross-referencing the electronic content with the media 10. The unique codes may be stored in a database (not explicitly shown).

The server is also configured to create an individualized online library 20 if the user or the recipient is a first-time user. This event is triggered by the user sending a message from the computing device 14 to the server. The server 16 hosts the online library 20 as a web page which can be accessed by the user through any computer having access to the World Wide Web.

Furthermore, the server 16 forwards the electronic content directly to the user's e-mail box 18, based on the e-mail address provided by the user. Users who have used the service previously, automatically get the articles delivered to their already registered e-mail addresses. First-time users also automatically receive an e-mail or an SMS from the server 16 containing instructions with the log-in details for the online library 20.

A user can share articles with another recipient by including the recipient's e-mail address or phone number in the SMS request message, thus, in effect forwarding the article to the recipient. In response to the request, the server 16 creates a personalized online library for the recipient containing the requested content. The server 16 also sends the recipient an SMS and/or e-mail message informing the recipient of the article and with log-in details for his/her personalized library.

FIG. 2 illustrates the method for delivery of electronic media. In step 100, providers upload electronic content. The providers have an on-line account allowing the providers to upload electronic content (e.g., articles, ads and other information) to the server 16. The server 16 catalogues the media-based content by assigning a unique code to content which references corresponding media 10. In step 110, provider of media 10 publishes the media 10 and includes the instructions 12 to provide the users with contact information and a unique code identifying the media 10. In step 120, the user contacts the server 16 requesting the electronic content based on the contact information and unique code included in the instructions 12. The user may include an email address, if the user or the recipient of the media 10 are first-time users.

In step 130, the server 16 determines whether the email address, if any, is a new e-mail address not associated with a corresponding online library 20. This may be the case where the requester or the recipient is the first-time user of the service. If the e-mail address does not have an online library 20, in step 140, the server creates an online library and replies to the request with instructions on how to access the online library 20. The server 16 may include a usage database of user requests and forwards to record the types of content requested by the user, such as subject matter, publication names, and other meta information. The usage database may then be utilized to suggest content based on historical patterns and individual preferences to the user and/or recipient.

The server 16 also organizes and parses the meta information associated with the requests for use with certain applications. In embodiments, the server 16 may implement an application that searches through the usage database and creates comparison matrices or an application that automatically sorts content based on topic, publication name, or certain consistent bits of information (e.g., recipes with asparagus, or articles containing the name of a certain pharmaceutical company). In step 150, the server 16 sends the electronic content to the computing device 14 and to the online library 20 where the requester or the recipient may access the media 10 at a later time. The electronic content may include links to e-commerce engines allowing the user to purchase additional content and/or products.

In another embodiment, the request for electronic content is accomplished by capturing an image of the media 10 via the computing device 14 which includes an image-capturing module, such as a camera equipped cellular phone or PDA (not explicitly shown) and then forwarding that image to the server 16. The user simply takes a picture of any portion (e.g., page) of the media 10. The image may be formatted using appropriate formatting application or system such as MMS (multi-media messaging service) short-code. The server 16 then extracts the image and runs an optical character-recognition or pattern matching routine to identify the particular media 10 and thereby identify corresponding electronic content to send to the recipient. More specifically, the server matches the image received with an image of the electronic version of the media in the database and then sends the electronic content to the user. In other embodiments, the media 10 may include a server-readable code to facilitate the image and/or character recognition process. The server-readable code may be an alphanumeric code, a graphic symbol, a full color graphic image (e.g., a full color graphic logo).

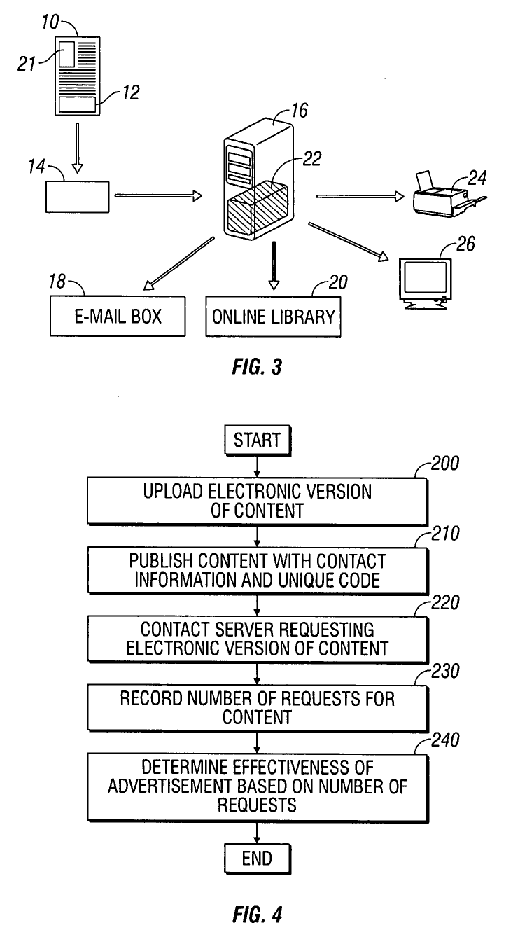

FIG. 3 shows a system for determining effectiveness of printed media advertising. The media 10 includes instructions 12 and one or more advertisements 21. The advertisements 21 may be any advertising material printed along the media 10, such as product and/or service ads. There exists a direct relation between user requests for electronic versions of the media 10 and the number of users who have viewed the advertisement, since when the users request the media 10 the users have already viewed the advertisements 21. Correlating the number of requests for the media 10 allows for determination of effectiveness of the advertisements 21.

The request for electronic version of the media 10 is sent to the server 16 which processes the request by retrieving the article and forwarding the article to the user. The server 16 includes a response processing module 22 which may be implemented as a standalone or imbedded software and/or hardware component of the server 16. The processing module 22 records the number of requests for each of the media 10 as well as name, email, phone numbers, and other information relating to the users. The processing module 22 includes a database for tracking the number of requests for each media 10. The processing module 22 determines the effectiveness of advertisement based on the response rate (e.g., number of times the media 10 was requested and forwarded). This is accomplished by calculating the ratio between the number of requests and the number of media 10 in circulation. Unlike conventional methods for calculating response rates which are limited in analyzing numbers of subscribers, the system according to the present disclosure analyzes all of the publications in the circulations thereby providing more detailed results since the sample is much broader.

In embodiments, the processing module 22 is coupled to the e-mail box 18 and counts the number of times an article has been read in electronic form. This provides for measurement of durability of content. The processing module 22 calculates a durability rating for each piece of media as a ratio of access times and availability time since publication.

The processing module 22 outputs the results, which include total number of requests, ratio of requests and circulation figures, effectiveness of the electronic content, number of times the content has been forwarded, etc. on a monitor 26 and/or printer 24. It is also envisioned the results may be output on a website accessible to the server administrators, publishers and/or advertisers. In embodiments, the advertisers may be given an ability to contact content requesters on a permission basis based on the behavior patterns (e.g., types of articles previously requested by the user, frequency of use, etc.) stored in the usage database.

FIG. 4 illustrates the method for determining effectiveness of advertising in the media 10. In step 200, providers upload electronic content. The server 16 catalogues the media-based content and the associated advertisements 21 by assigning a unique code to content which references corresponding media 10. In step 210, provider of media 10 publishes the media 10 including the advertisements 21 and includes the instructions 12 providing users with contact information and the unique code identifying the media 10. In step 220, the user contacts the server 16 requesting the electronic content based on the contact information and the unique code included in the instructions 12.

In step 230, the server 16 records each request for the media 10, including forwarding requests as well as other information relating to the users (e.g., name, email, phone numbers, etc.) to obtain the total number of requests for the media 10. In step 240, the processing module calculates the ratio between the number of requests and the number of media 10 in circulation to determine the effectiveness of advertisements 21 based on the response rate (e.g., number of times media 10 was requested).

The system and method according to the present disclosure provide publishers of newspapers and magazines with a new channel to easily distribute their content. The solution is very suitable for a broad range of content types, such as business and science articles, do-it-yourself articles, nutrition tips, cooking recipes, advertisements, coupon distribution, etc. Publishers will also obtain highly valuable feedback data about which articles are requested. This data can help them to develop and target their editorial focus. Moreover, publishers can charge a fee for the articles, which the users may pay conveniently through their phone bill.

It is also envisioned that the users may request a subscription (e.g., hardcopy and/or electronic delivery) to a publication via the disclosed system and method. The user may transmit delivery address information to the contact provided and thereby automatically subscribe for home delivery of the magazine and/or newspaper.

In addition to requesting electronic content of various forms of media, it is envisioned that the present disclosure may also be adapted for obtaining further information about any type of physical objects. In one embodiment, the user captures an image of an object and forwards the image to the server, which then identifies the object via an optical recognition process and generates a response to the user. This may be applied to obtaining additional information on television broadcasts. The user captures a screenshot of the broadcast and forwards the same to the server. The server then determines the broadcast corresponding to the screenshot based on image recognition (e.g., the broadcast includes a readable logo) and the time at which the screenshot was captured. The server then forwards appropriate content to the user, which may include relevant information about an actor, a travel destination, a recipe to a cooking show, etc. Another possible application of this embodiment is directed to obtaining information on retail products, such as purchases of used automobiles, books, and other items. The user captures and transmits an image of the vehicle identification number (“VIN”) or a license plate to the server, which then parses the image and transmits detailed information about that vehicle, including competitive price reports, vehicle history, reviews etc. With respect to books and other items, the user simply photographs the identifying code located on such items, such as international standard book number (“ISBN”) or universal product code (“UPC”), and transmits the code to the server. The server then processes the code and provides the user with information relating to the product. The image-capture system may also be used to add the items to the user's so-called “wish-list” (e.g., registry).

The system and method of the present disclosure also provide for a novel way of precisely tracking advertisement response rates by measuring number of requests for particular articles in the media.

The main innovations and advantages of present disclosure are: convenience of being able to obtain an article in electronic format just by sending an SMS, immediate delivery of an electronic copy of the article, and access to a personalized online library containing all requested articles. The main customers for this innovation are envisioned to be publishers of printed media such as magazines and newspapers and the advertisers.

While the disclosure has been shown and described with reference to certain particular embodiments thereof, it will be understood by those skilled in the art that various changes in form and detail may be made therein without departing from the scope of the disclosure.

What is claimed is:

1. A system for electronic distribution of media comprising:
media including instructions having contact information, a unique code identifying the media and at least one advertisement associated therewith;
a computing device configured to transmit an electronic message based on the contact information requesting electronic content corresponding to the media, the electronic message including the unique code; and
at least one server configured to store the electronic content and to catalogue the electronic content by the unique code, the at least one server is further configured to determine effectiveness of the at least one advertisement based on number of electronic messages requesting electronic content corresponding to the media.

2. A system according to claim 1, wherein the server is further configured to record information relating to electronic messages requesting electronic content corresponding to the media.

3. A system according to claim 1, wherein the server is further configured to determine effectiveness of the at least one advertisement based on a ratio between number of electronic messages requesting electronic content corresponding to the media and number of media in circulation.

4. A system according to claim 1, wherein the electronic content is selected from the group consisting of an electronic version of the media, an on-demand rich media presentation, and a coupon.

5. A system according to claim 1, the server is further configured to generate an individualized online library and to deliver the electronic content to at least one of the computing device, an e-mail box and the online library.

6. A system according to claim 5, wherein the electronic message further includes an e-mail address identifying the e-mail box.

7. A system according to claim 5, wherein the online library is a web page accessible via the World Wide Web.

8. A system according to claim 1, wherein the electronic message is an SMS message.

9. A system according to claim 1, wherein the server is further configured to determine a durability rating for the media as a function of a ratio of number of times the electronic content was accessed and duration of availability of the electronic content.

10. A method for electronic distribution of media, comprising the steps of:
providing media including instructions having contact information, a unique code identifying the media and at least one advertisement associated therewith;
cataloguing electronic content corresponding to the media to assign the unique code thereto;
transmitting an electronic message based on the contact information, the electronic message including the unique code; and
determining effectiveness of the at least one advertisement based on number of electronic messages requesting electronic content corresponding to the media.

11. A method according to claim 10, further comprising the steps of:
generating an individualized online library; and
delivering the electronic content to the at least one of the computing device, an e-mail box and the online library.

12. A method according to claim 10, wherein the step of transmitting further includes the step of transmitting the electronic message including an e-mail address identifying the e-mail box.

13. A method according to claim 10, further comprising the step of:
recording information relating to electronic messages requesting electronic content corresponding to the media.

14. A method according to claim 10, further comprising the step of:
determining effectiveness of the at least one advertisement based on a ratio between number of electronic messages requesting electronic content corresponding to the media and number of media in circulation.

15. A method according to claim 10, wherein the electronic content is selected from the group consisting of an electronic version of the media, an on-demand rich media presentation, an advertisement and a coupon.

16. A system for electronic distribution of media comprising:
media including instructions having contact information, a unique code identifying the media and at least one advertisement associated therewith;
a computing device configured to transmit an electronic message based on the contact information requesting electronic content corresponding to the media, the electronic message including the unique code; and
at least one server configured to store the electronic content and to catalogue the electronic content by the unique code, the at least one server is further configured to record information relating to electronic messages requesting electronic content corresponding to the media and to determine effectiveness of the at least one advertisement based on a ratio between number of electronic messages requesting electronic content corresponding to the media and number of media in circulation.

17. A system according to claim 16, wherein the electronic content is selected from the group consisting of an electronic version of the media, an on-demand rich media presentation, and a coupon.

18. A system according to claim 16, the server is further configured to generate an individualized online library and to deliver the electronic content to at least one of the computing device, an e-mail box and the online library.

19. A system according to claim 18, wherein the electronic message further includes an e-mail address identifying the e-mail box.

20. A system according to claim 18, wherein the online library is a web page accessible via the World Wide Web.

21. A system according to claim 15, wherein the electronic message is an SMS message.

22. A system for electronic distribution of media comprising:
a computing device including an image-capturing module configured to capture an image of at least a portion of a media, the computing device configured to transmit an electronic message including the image, the electronic message requesting electronic content corresponding to the media; and
at least one server configured to store the electronic content and to catalogue the electronic content, the at least one server is further configured to analyze the image to identify the media and to generate an individualized online library, wherein the at least one server delivers the electronic content to at least one of the computing device, an e-mail box and the online library.

23. A system according to claim 22, wherein the at least one server is further configured to record information relating to electronic messages requesting electronic content corresponding to the media and to determine effectiveness of the at least one advertisement based on a ratio between number of electronic messages requesting electronic content corresponding to the media and number of media in circulation.
